(19) United States
(12) Patent Application Publication
(10) Pub. No.: US 2007/0248712 A1
(43) Pub. Date: Oct. 25, 2007

(54) CORRUGATING ROLLER FOR MACHINES TO PRODUCE CORRUGATED CARDBOARD AND MACHINE COMPRISING SAID ROLLER

(75) Inventors: Mauro ADAMI, Lucca (IT); Desiderio Garcia, Paplona Navarra (ES)

Correspondence Address: McGLEW AND TUTTLE;John James McGlew, Scarborough Station, Scarborough, NY, 10510-9227, US

(73) Assignee: FOSBER S.P.A.,

(21) Appl. No.: 11/769,258

(22) Filed: Jun. 27, 2007

Related U.S. Application Data
(62) Division of application No. 10/860,500, filed on Jun. 3, 2004.

(30) Foreign Application Priority Data
Jun. 4, 2003 (IT) FI2003A000159

(51) Int. Cl. B31F 1/28

(52) U.S. Cl. 425/369

(57) ABSTRACT

The corrugating roller (7; 9) for machines to produce corrugated cardboard, comprises: a hollow cylindrical body (7B; 9B), with an outer (7D; 9D) surface provided with corrugations (72C; 9C); a circuit for a heat-carrying fluid; and a pair of necks (7E, 7F; 9E, 9F), through at least a first (7E; 9E) of which said heat-carrying fluid is supplied. The body (7B) and the necks (7E, 7F) are produced in a single block machined by removal.

### CROSS REFERENCE TO RELATED APPLICATIONS

This application is a divisional application under 37 CFR 1.53(b) of pending prior application Ser. No. 10/860,500 filed Jun. 3, 2004.

### FIELD OF THE INVENTION

The present invention pertains to a corrugating roller to produce corrugated cardboard.

The invention also relates to a “single facer” machine to produce corrugated cardboard, comprising a pair of corrugating rollers, between which a sheet of corrugated cardboard passes, and a pressure system to couple the sheet of corrugated cardboard with a sheet of smooth cardboard.

### BACKGROUND OF THE INVENTION

The corrugated cardboard is composed of a plurality of sheets of cardboard, alternately smooth and corrugated, glued to one another. To produce this type of cardboard, corrugating or “single facer” machines are used, wherein a pair of corrugating rollers, provided with longitudinal grooves that mesh together, form a nip through which a first sheet of cardboard passes, which is corrugated and provided with a glue on the crests of the flutes. The corrugated sheet is then glued to a smooth sheet or “cover”. The product thus obtained can be provided with a second smooth sheet, or cover. Differently, several products coming from a corrugating machine can be superimposed and glued to obtain a corrugated cardboard with several layers.

Corrugating machines of this type are described in EP-A-870598, EP-A-601528, US-A-6068701, EP-A-786329, EP-A-1086805, US-A-20010047850, US-A-5415720, EP-A-734849.

Corrugating rollers are relatively complex components. In fact, they have an internal heating circuit through a heat-carrying fluid, typically steam. The heat-carrying fluid circuit has an internal duct and a series of external ducts, in proximity to the cylindrical surface of the roller, to obtain efficient heat exchange.

Due to their complex nature, currently known corrugating rollers are produced with several components. For example, US-A-4,917,664 describes a corrugating roller constituted by two head ends on which the shanks or necks to support the roller are provided. The head ends are connected to a hollow cylindrical body, on the outer surface of which ribs or grooves are produced to perform corrugation of the cardboard, and in the cylindrical wall of which ducts are produced parallel to the axis of the roller for circulation of the heat-carrying fluid. The ducts are disposed to allow the heat-carrying fluid to flow alternately in one direction and in the opposite direction.

ES-B-2070726 describes a corrugating roller comprising a interchangeable external cylindrical jacket, on which grooves or corrugations are produced, fitted on a grooved and radially perforated central core. Once the jacket has been mounted on the central core, these grooves form longitudinal ducts for circulation of the heat-carrying fluid. The core is axially perforated to define an inlet duct and an outlet duct of the heat-carrying fluid. It forms, with its ends, the end necks or shanks of the roller.

ES-A-2110871 describes a corrugating roller comprising a hollow cylindrical body, at the ends of which two portions forming the shanks or necks of the roller are inserted. One of the two portions has an inlet duct and an outlet duct for the heat-carrying fluid, which circulates in an interspace with an annular section formed by the inner wall of the hollow cylindrical body and by a pipe coaxial to said body.

EP-B-657275 describes a corrugating roller comprising a hollow cylindrical body, in the wall of which circulation ducts for the heat-carrying fluid are produced. The ducts are fed through head ends forming the necks or shanks supporting the roller. The head ends are inserted into the axial cavity of the cylindrical body.

US-A-5899264 and EP-A-1962590 describe a corrugating roller constituted by a hollow cylindrical body, in the wall of which ducts for circulation of the heat-carrying fluid are produced. The fluid is fed through an axial hole produced in one head end of the roller, fixed to the central cylindrical body and passes through a duct coaxial to the cylinder, extending through the hollow cylindrical body thereof, to the opposite head end from which the fluid is distributed radially to the peripheral ducts produced in the cylindrical wall of the body of the roller. Radial holes in the first head end collect the spent heat-carrying fluid and convey it outside.

All the constructional solutions described in the aforesaid documents are complex and costly and in some cases somewhat inefficient from a thermal point of view, as they do not allow efficacious heating of the outer surface of the corrugating roller.

### SUMMARY OF THE INVENTION

The object of the present invention is the production of a corrugating roller for corrugating machines to produce corrugated cardboard which is simple and inexpensive to produce, maintaining a high level of thermal efficiency, that is high characteristics of heat exchange between the heat-carrying fluid and the roller towards the outer surface thereof.

Essentially, according to the invention, a corrugating roller is provided for machines to produce corrugated cardboard, comprising: a hollow cylindrical body, with an outer surface provided with corrugations; a circuit for a heat-carrying fluid; and a pair of necks, through at least a first of which said heat-carrying fluid is supplied. Characteristically, according to the invention, the body and the necks are produced in a single block machined by removal. This simplifies and reduces the construction costs of the corrugating rollers.

According to a practical embodiment, the corrugating roller comprises an axial cavity extending through a first of said two necks and essentially for the entire axial extension of the cylindrical body of the roller, and a plurality of peripheral longitudinal ducts, parallel to the axis of the roller in proximity to the cylindrical surface of said body, in communication with the axial cavity through a first series of essentially radial ducts and a second series of essentially radial ducts for flow of the heat-carrying fluid from the axial cavity into said peripheral longitudinal ducts and therefrom back into the axial cavity. The axial cavity, the longitudinal ducts and the radial ducts are advantageously obtained by boring.

Further advantageous characteristics and embodiments of the roller according to the invention are indicated in the attached dependent claims.

The invention also relates to a corrugating machine comprising two corrugating rollers, one of which or preferably both of which are produced by a single block of material machined by mechanical removal.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which the preferred embodiment of the invention is illustrated.

### BRIEF DESCRIPTION OF THE DRAWINGS

In the drawings:

FIG. 1 shows a side view of a corrugating machine;

FIGS. 2 and 3 show longitudinal sections of the two corrugating rollers, respectively lower and upper, of the machine in FIG. 1;

FIG. 3A shows an enlargement of an end portion of a roller; and

FIGS. 4 and 5 show cross sections according to IV-IV and V-V in FIGS. 2 and 3 respectively.

### DESCRIPTION OF THE PREFERRED EMBODIMENT

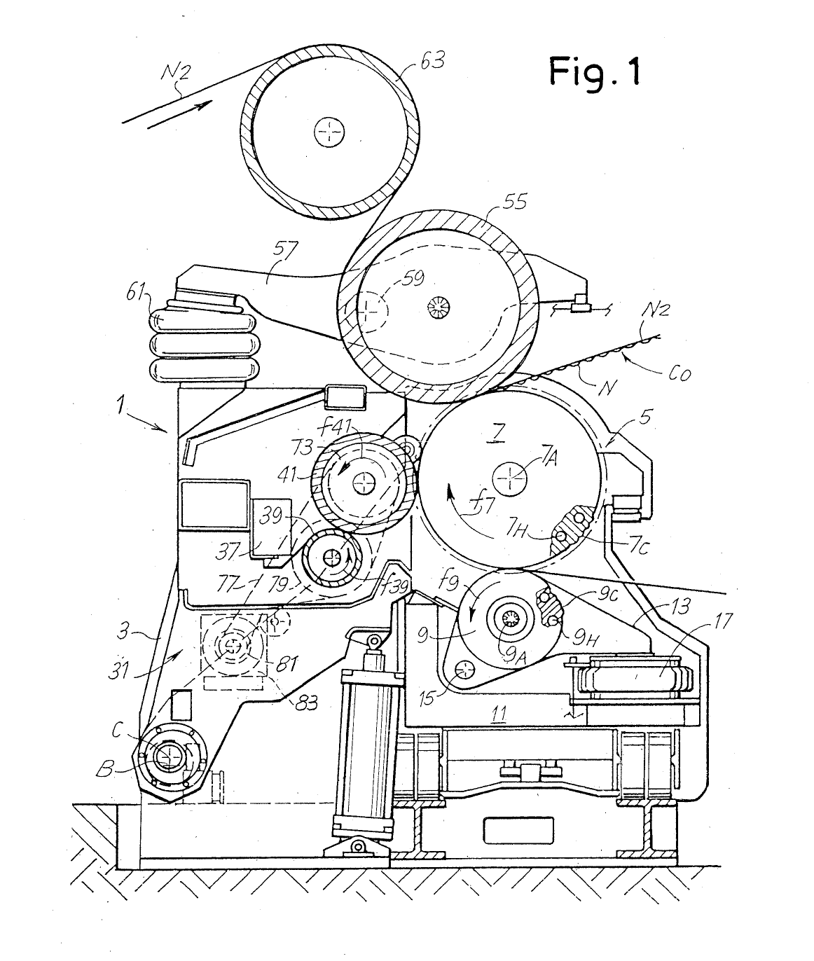

Referring to the drawings in particular, FIG. 1 shows a corrugating machine or “single facer” in which the invention may be incorporated. The machine, indicated as a whole with 1, has a load-bearing structure 3, inserted into which is a unit 5 comprising a first corrugating roller 7 and a second corrugating roller 9.

On its cylindrical surface the corrugating roller 7 has a plurality of ribs or corrugations 7C, meshing with corresponding corrugations or ribs 9C of the second corrugating roller 9. A web material N, such as a sheet of paper or cardboard, is made to pass through the nip defined between the two rollers 7 and 9, where the ribs 7C and 9C mesh with each other, to be subjected to corrugation between the two rollers 7 and 9 and remains adherent, upon delivery from the nip between said rollers, to the first corrugating roller 7.

The first corrugating roller 7 rotates about an axis 7A according to the arrow f7, the axis 7A being essentially fixed with respect to the unit 11 that supports the rollers 7 and 9. Differently, the second corrugating roller 9 is carried by a pair or arms 13 hinged about an axis of oscillation 15, parallel to the axis 7A of the first corrugating roller 7 and to the axis 9A about which the second corrugating roller 9 rotates according to the arrow f9. The second corrugating roller 9 is stressed against the first corrugating roller 7 by a pair of actuators (in the example shown a pair of “torpress”) indicated with 17 and acting on the two end arms 13 supporting the axis 9A of the corrugating roller 9.

A gluing unit, indicated as a whole with 31, is fastened to the structure 3 of the machine. The gluing unit 31 is hinged about an axis of oscillation B parallel to the axes 7A and 9A of the corrugating rollers 7 and 9.

The gluing unit 31 bears a glue tank 37, from which glue is collected by a transfer cylinder 39 rotating according to the arrow f39. The transfer cylinder 39 is tangent to a gluing cylinder 41 rotating according to f41 in the same direction as the transfer cylinder 39 and in contact therewith. In this way glue is transferred from the tank 37 to the cylindrical surface of the gluing cylinder 41 and therefrom to the crests of the web material N driven about the first corrugating roller 7 and previously deformed in the nip between the corrugating roller 7 and the corrugating roller 9.

Along the extension of the corrugating roller 7, downstream of the gluing area defined by the position of the gluing cylinder 41, a pressure roller 55 is provided, supported by a pair of arms 57 hinged in 59 to the fixed structure 3 and stressed by actuators 61 so as to press the pressure roller 55 against the corrugating roller 7. A second continuous web material, for example a sheet of paper material indicated with N2, guided by a cylinder 63, is driven about the pressure roller 55. The web material N2 is applied with pressure by the roller 55 on the crests of the web material N previously provided with glue by means of the gluing cylinder 41. The second web material N2 constitutes the “cover” of the corrugated cardboard produced by the machine. Said cardboard, indicated with CO, is thus constituted by the corrugated web material N glued to the smooth web material N2. In a per se known way, this material is subsequently fed to another machine for a second smooth sheet to be applied to the opposite side and, if necessary, combined with other sheets of corrugated cardboard.

The corrugating rollers 7 and 9 are heated internally by circulation of a heat-carrying fluid, typically steam. Characteristically, according to the present invention, the corrugating rollers are produced in a single piece, that is “monobloc”, and the channels for fluid circulation, and the supporting necks are produced by machine removal from a single block.

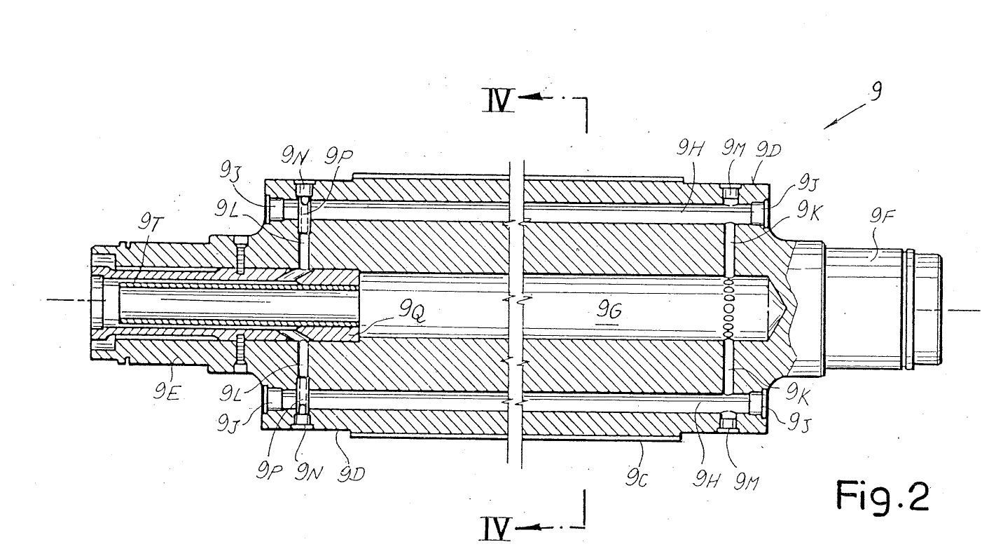

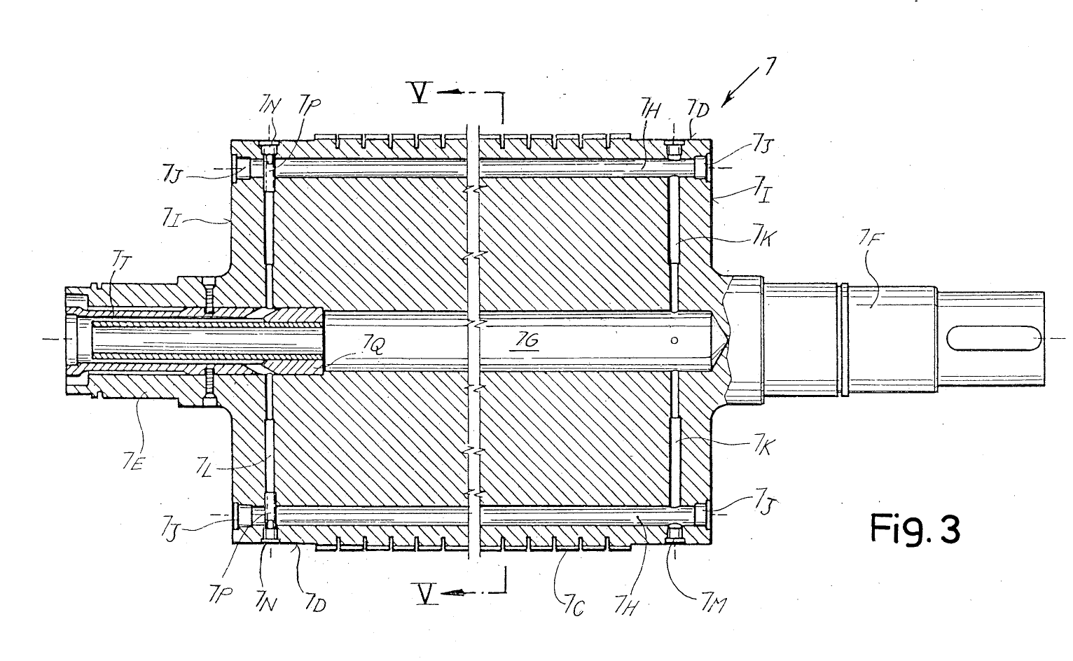

The configuration of the two rollers 7 and 9 is represented in FIGS. 2 to 5. In particular, the roller 7 (FIG. 3) has a cylindrical body 7B with an essentially cylindrical side surface 7D provided with corrugations 7C. In proximity to the head ends of the roller the cylindrical surface 7D has two essentially smooth bands or annular areas, that is without corrugations.

Two necks 7E, 7F produced in one piece by turning from the same metal block forming the main cylindrical body 7B, are integral with the main cylindrical body 7B.

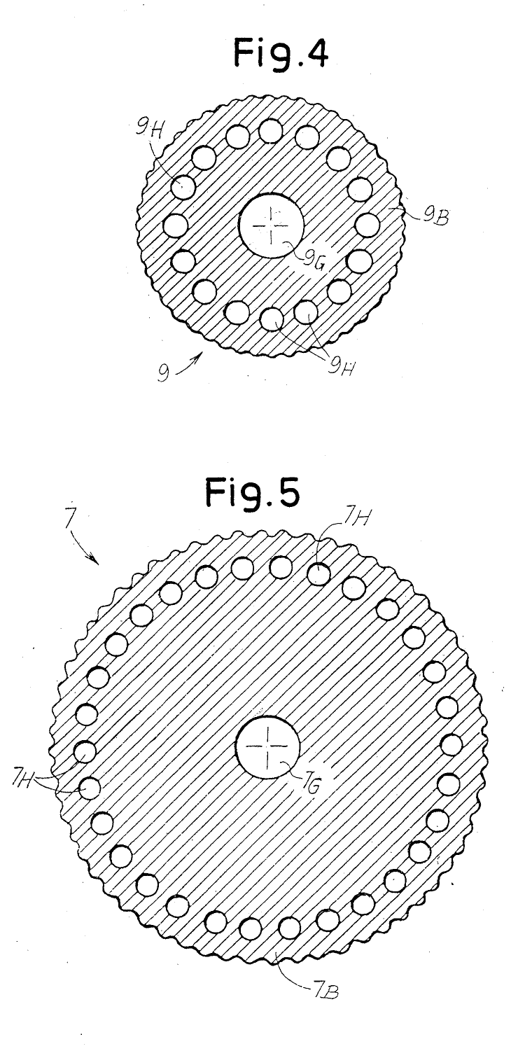

An axial cavity 7G extends through the neck 7E, also extending along the axis of the cylindrical body 7B until it is in proximity to the neck 7F. Moreover, peripheral longitudinal ducts 7H are produced in the cylindrical body 7B, distributed (see FIG. 5) with their axes on a geometrical cylindrical surface coaxial to the cylindrical surface 7D of the corrugating roller 7. The peripheral longitudinal ducts 7H are produced by means of perforation of the cylindrical body 7B and emerge on the opposed and parallel base surfaces 71 of the roller. The peripheral longitudinal ducts 7H are closed at their ends by caps 7J.

Two series of essentially radial ducts, indicated with 7K and 7L, are produced by means of perforation from the outside in proximity to the head ends of the cylindrical body 7B, at the level of the two smooth bands of the outer surface 7D. Each radial duct intersects a corresponding peripheral longitudinal duct 7H and emerges in the axial cavity 7G. The surface holes produced to create the radial ducts 7K and 7L are closed with caps 7M and 7N.

At the level of the caps 7N elements 7P are inserted in the radial ducts 7L to discharge the steam condensate that forms in the peripheral longitudinal ducts 7H. These elements are visible in particular in the enlargement in FIG. 3A and their function is per se known and therefore does not require a detailed description.

A distributor element 7Q is inserted into the axial cavity 7G inside the neck 7E, the structure of which is visible in particular in the enlarged detail in FIG. 3A. The distributor element 7Q has an essentially cylindrical extension, with an internal passage 7R coaxial to the cavity 7G, inside which a small tube 7S is inserted. The small tube forms a fluid passage for delivery of the heat-carrying fluid, coming from a rotating manifold, not shown and per se known, towards the inside of the cavity 7G. A fluid passage with an annular section 7T, in which the radial ducts 7L emerge, through inclined holes 7U produced in the cylindrical wall of the distributor element 7Q, is defined between the outer wall of the small tube 7S and the surface of the inner passage 7R of the distributor element 7Q. The spent heat-carrying fluid coming from the radial ducts 7L is collected through the fluid passage with annular section 7T.

Therefore, by means of mechanical machining of a single metal block, a channel is formed in the roller 7 for the heat-carrying fluid which from the distributor element 7Q makes the heat-carrying fluid circulate from the neck 7E into the cavity 7G, through the radial ducts 7K, in the peripheral longitudinal ducts 7H and therefrom through the radial ducts 7L back towards the distributor element 7Q and herefrom to the rotating manifold, not shown. The heat-carrying fluid yields the majority of its heat to the outer cylindrical surface 7D and to the ribs or corrugations 7C of the roller.

As can be seen in the drawing, the axial cavity 7G has a relatively small diameter with respect to the diameter of the cylindrical surface 7D of the roller and the peripheral longitudinal ducts are positioned closer together with respect to said surface 7D. In this way heat distribution is optimized through a heat-carrying fluid that enters the cavity 7G and circulates therefrom into the peripheral longitudinal ducts 7H and by conduction heats the surface 7D and in particular the corrugations or ribs 7C. In particular, the diameter of the axial cavity 7G can be from a fourth to an eighth of the diameter of the cylindrical surface 7D. Differently, the diameter of the geometrical cylindrical surface on which the peripheral longitudinal ducts lie is equal to or greater than more or less two thirds and preferably equal to or greater than three quarters of the diameter of the cylindrical surface 7D, so that the ducts are located in proximity to the outer surface of the roller.

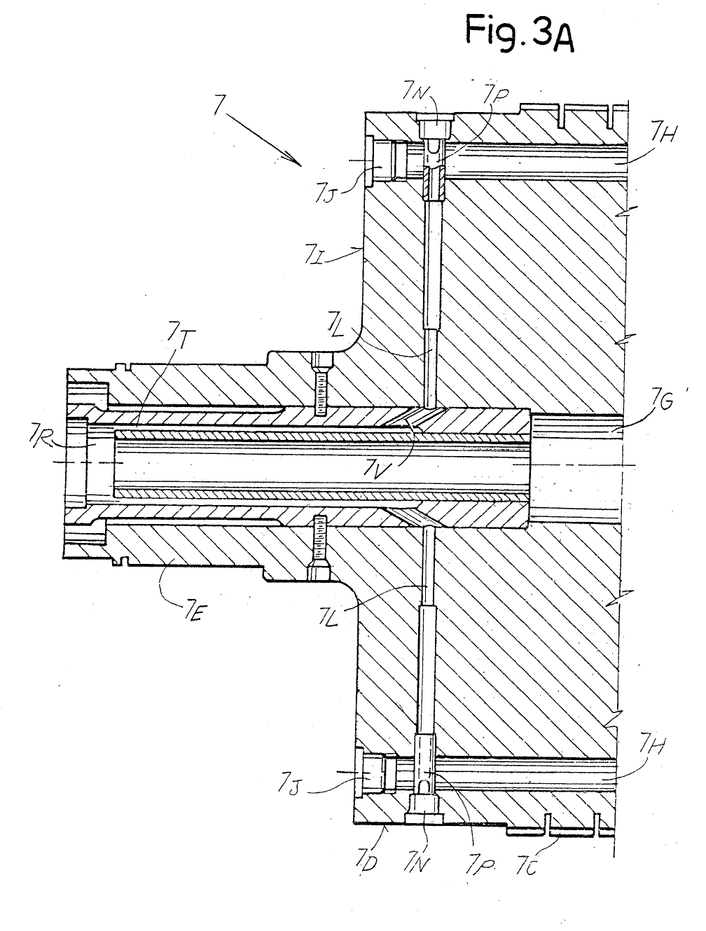

FIGS. 2 and 4 show the structure of the roller 9. This structure is conceptually identical to the structure of the roller 7 with the exception of the different dimensions, as the roller 9 has an essentially smaller diameter. The various parts of the roller 9 shown in FIGS. 2 and 4 are indicated with the number 9 followed by the same letter utilized in FIGS. 3, 3A and 5 for the corresponding parts of the roller 7. It can be seen in the drawing that in this case the diameter of the internal cavity 9G is greater with respect to the diameter of the cylindrical outer surface 9D of the roller, the diameter of the cavity 9G being more or less equal to a quarter of the outer diameter of the cylindrical surface. This is in view of the fact that the cross section of the cavities 7G and 9G must be essentially equal or similar to have the same flow rate of heat-carrying fluid.

The longitudinal axes of the peripheral longitudinal ducts are on an ideal cylindrical surface with a diameter approximately equal to three quarters of the outer diameter of the cylindrical surface 9D and therefore in proximity to said surface to optimizie heat exchange.

In the example shown, the inlet and outlet of the steam for heating the roller are disposed on the same side of the roller. Nonetheless, it must be understood that the inlet and outlet could also be disposed on opposite sides of the roller.

The drawing purely shows a practical embodiment of the invention, which may vary in shapes and layouts without however departing from the scope of protection defined by the claims. Any reference numbers in the claims are provided purely for the purpose of facilitating reading in the light of the description and drawings and do not limit the scope of protection.

While specific embodiments of the invention have been shown and described in detail to illustrate the application of the principles of the invention, it will be understood that the invention may be embodied otherwise without departing from such principles.

What is claimed is:

1. A corrugating roller for machines to produce corrugated cardboard, the corrugating roller comprising:
a cylindrical body including a defined longitudinal axis, an outer surface provided with corrugations and a first end surface and a second end surface disposed opposite said first end surface;
a circuit for a heat-carrying fluid;
a pair of necks monolithically connected with said hollow cylindrical body on either ends, said heat-carrying fluid being supplied through at least a first of said pair of necks, said body and said necks being integrally connected by being machined from a single block of material;
a cap;
a longitudinally extending central cavity in fluid connection with at least one of said necks;
a plurality of longitudinally extending ducts arranged peripherally about said central cavity and said longitudinal axis, each duct extending from said first front end to said second front end, said cap being fixed to each distal end of each longitudinally extending duct at said first end surface and said second end surface;
a plurality of fluid feeding ducts extending from said central cavity to said outer surface, each fluid feeding duct intersecting one of said longitudinally extending ducts, each fluid feeding duct being closed by said cap at said outer surface;
a plurality of fluid removal ducts extending from said outer surface to said central cavity, each fluid removal duct intersecting one of said longitudinally extending ducts, each fluid removal duct being closed at said outer surface via said cap.

2. A corrugating roller as claimed in claim 1, wherein said longitudinally extending central cavity extends through substantially an entire axial extension of said cylindrical body of the roller, and is in fluid communication with an axial cavity through said first of said pair of necks.

3. A corrugating roller as claimed in claim 2, wherein disposed in said first neck, inside said axial cavity is a distributor element with a central axial hole and an annular hole coaxial with each other, said central axial hole defining a fluid passage between the outside of the roller and said longitudinally extending central cavity of the roller and said annular hole defining a fluid passage between the outside of the roller and said peripheral longitudinally extending channels through said plurality of fluid removal ducts.

4. A corrugating roller as claimed in claim 1, wherein said plurality of fluid feeding ducts and said plurality of fluid removal ducts emerge on the outer surface of said cylindrical body at the level of two annular bands without said corrugations.

5. A corrugating roller as claimed in claim 1, wherein elements are disposed in an intersection between said peripheral longitudinally extending ducts and said plurality of fluid removal ducts to discharge the condensate forming in said peripheral longitudinally extending ducts.

6. A corrugating roller as claimed in claim 2, wherein said longitudinally extending central cavity has a diameter equal to or smaller than approximately a quarter of the outer diameter of the roller.

7. A corrugating roller as claimed in claim 1, wherein the axes of said peripheral longitudinally ducts are disposed along a geometrical cylindrical surface, the diameter of which is approximately equal to at least three quarters of the outer diameter of the corrugating roller.

8. A corrugating roller according to claim 1, wherein said longitudinally extending ducts are substantially parallel to said longitudinal axis.

9. A corrugating roller according to claim 1, wherein said fluid feeding ducts are substantially radial.

10. A corrugating roller according to claim 1, wherein said fluid removal ducts are substantially radial.

11. A corrugating roller according to claim 2, wherein said plurality of fluid feeding ducts and said plurality of fluid removal ducts emerge on the outer surface of said cylindrical body at the level of two annular bands without said corrugations.

12. A corrugating machine for producing corrugated cardboard, the machine comprising:
a first corrugating roller including a cylindrical body having a defined longitudinal axis, an outer surface provided with corrugations and a first end surface and a second end surface;
a circuit for a heat-carrying fluid;
a pair of necks formed monolithically with said hollow cylindrical body on either ends, said heat-carrying fluid being supplied through at least a first of said pair of necks, said body and said necks being integrally connected from machining a single block of material; and
a second corrugating rollers;
wherein said circuit includes:
a first plug;
a second plug;
a third plug;
a longitudinally extending central cavity in fluid connection with at least one of said necks;
a plurality of longitudinally extending ducts arranged peripherally about said central cavity and said longitudinal axis, each duct extending from said first end surface to said second end surface, said first plug being fixed to each distal end of each longitudinal extending duct to seal each longitudinally extending duct at said first end surface and said second end surface;
a plurality of fluid feeding ducts extending from said central cavity to said outer surface, each fluid feeding duct having a distal end located at said outer surface, said second plug being fixed to said distal end; and
a plurality of fluid removal ducts extending from said outer surface to said central cavity, each fluid removal duct having a distal end located at said outer surface, said third plug being fixed to said distal end.

13. A corrugating machine according to claim 12, wherein said longitudinally extending central cavity extends through substantially an entire axial extension of said cylindrical body of the roller, and is in fluid communication with an axial cavity through said first of said pairs of necks.

14. A corrugated roller for machines to produce corrugated cardboard, the corrugated roller comprising:
a hollow cylindrical body having a defined longitudinal axis, having an outer surface provided with corrugations and having two end surfaces;
a circuit for a heat-carrying fluid;
a pair of necks monolithically connected with said hollow cylindrical body on either ends, said heat-carrying fluid being supplied through at least a first of said pair of necks, said body and said necks being integrally connected by being machined from a single block of material;
a cap;
a longitudinally extending central cavity in fluid connection with at least one of said necks;
a plurality of longitudinally extending ducts arranged peripherally about said central cavity and said longitudinal axis, each duct extending to one of said ends, said cap being fixed to at least one distal end of each longitudinally extending ducts;
a plurality of fluid feeding ducts extending from said central cavity to said outer surface, said cap being fixed to each distal end of each fluid feeding duct located at said outer surface whereby each fluid feeding duct is sealed at said outer surface;
a plurality of fluid removal ducts extending from said outer surface to said central cavity, said cap being fixed to each distal end of each fluid removal duct located at said outer surface whereby each fluid feeding duct is sealed at said outer surface.

15. A corrugating machine for producing corruagted cardboard, the machine comprising:
a first corrugating roller including a cylindrical body having a defined longitudinal axis, an outer surface provided with corrugations and two front end surfaces;
a circuit for heat-carrying fluid;
a pair of necks formed monolithically with said hollow cylindrical body on either ends, said heat-carrying fluid being supplied through at least a first of said pair of necks, said body and said necks being integrally connected from machining a single block of material;
a second corrugating roller;
wherein said circuit includes:
a cap;
a longitudinally extending central cavity in fluid connection with at least one of said necks;
a plurality of longitudinally extending ducts arranged peripherally about said central cavity and said longitudinal axis, each duct extending to one of said front ends, said cap being fixed to at least one distal end of each longitudinally extending ducts;
a plurality of fluid feeding ducts extending from said central cavity to said outer surface, said cap being fixed to each distal end of each fluid feeding duct located at said outer surface whereby each fluid feeding duct is sealed at said outer surface; and
a plurality of fluid removal ducts extending from said outer surface to said central cavity, said cap being fixed to each distal end of each fluid removal duct located at said outer surface whereby each fluid feeding duct is sealed at said outer surface.

16. A method for producing a corrugating roller for machines to produce corrugated cardboard, the method comprising:
providing a single block of material;
machining at least one of a pair of necks, a central axial cavity, a plurality of longitudinal ducts, and radial ducts from said single block of material;
repeating said machining step until the structural characteristics of said central axial cavity forming a hollow cylindrical body with an outer surface provided with corrugations, said plurality of longitudinal ducts forming a circuit for a heat-carrying fluid, said pair of necks through at least a first of which said heat-carrying fluid is supplied, and said radial ducts are formed on said single block of material; and
end closing said radial ducts and said longitudinal ducts.

17. A method according to claim 16, further comprising the steps of:
machining an axial cavity along an axis of roller, in a first of said pair of necks;
machining a plurality of peripheral longitudinal ducts, parallel to said axis of the roller in proximity to said outer surface and ending on front surfaces of said roller;
machining a first series of essentially radial ducts and a second series of essentially radial ducts for flow of said heat-carrying fluid from said axial cavity into said peripheral longitudinal ducts and therefrom back into said axial cavity, said radial ducts ending on said outer surface and intersecting said longitudinal ducts; and
closing the ends of said longitudinal ducts and said radial ducts.

18. A method according to claim 17, further comprising the steps of:
machining an extended cavity running through an entire extension of said cylindrical body, said extended cavity being in communication with said axial cavity.

19. A method according to claim 17, wherein said radial ducts are constituted by essentially radial holes extending from the side surface of said cylindrical body to said axial cavity and closed radially from the outside by respective closing caps.

20. A method according to claim 19, wherein disposed in said first neck, inside said axial cavity is a distributor element with a central axial hole and an annular hole coaxial with each other, a fluid passage being defined by means of a central axial hole between the outside of the roller and said axial cavity of the roller and a fluid passage being defined by means of an annular hole between the outside of the roller and said peripheral longitudinal channels through said second series of essentially radial ducts.

21. A method according to claim 17, wherein said axial cavity has a diameter equal to or smaller than approximately a quarter of the outer diameter of the roller.

22. A method according to claim 17, wherein the axes of said peripheral longitudinal ducts are disposed along a geometrical cylindrical surface, the diameter of which is approximately equal to at least three quarters of the outer diameter of the corrugating roller.
